(19) United States
(12) Patent Application Publication
(10) Pub. No.: US 2008/0120649 A1
(43) Pub. Date: May 22, 2008

(54) APPARATUS AND METHOD FOR PROVIDING DIGITAL MULTIMEDIA BROADCASTING SERVICE IN PORTABLE TERMINAL

(75) Inventor: Dong-Wan Seo, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/940,695

(22) Filed: Nov. 15, 2007

(30) Foreign Application Priority Data
Nov. 21, 2006 (KR) 2006-0115017

(51) Int. Cl. H04N 5/445

(52) U.S. Cl. 725/39

(57) ABSTRACT

Provided are a method for providing DMB service in a portable terminal and an apparatus employing the method. The method includes receiving and analyzing ESG data or EPG data, and characteristics of broadcast contents of respective channels are checked when a DMB view request event occurs. Contents of the respective channels are mapped with pre-stored images having the same characteristics as the checked characteristics. A list of the respective channels is displayed, and a selection of a certain channel is received from a user. An image mapped with contents of the certain channel is displayed until the contents of the certain channel are received.

### PRIORITY

This application claims priority under 35 U.S.C. § 119 to an application filed in the Korean Intellectual Property Office on Nov. 21, 2006, entitled “Apparatus And Method For Providing Digital Multimedia Broadcasting Service In Portable terminal” and assigned Serial No. 2006-115017, the contents of which are incorporated herein by reference.

### BACKGROUND OF THE INVENTION

1. Field of the Invention

The present invention relates generally to an apparatus and method for providing digital multimedia broadcasting service in a portable terminal, and more particularly, to an apparatus and method for displaying an image showing contents broadcast on a certain channel prior to receiving the contents broadcast on the channel, using an Electronic Service Guide (ESG) or an Electronic Program Guide (EPG).

2. Description of the Related Art

Due to a recent increased level of user interest in digital multimedia broadcasting such as Digital Multimedia Broadcasting (DMB), Digital Video Broadcasting-Handheld (DVB-H), and Media Forward Link Only (MediaFLO), active research is being conducted to provide digital media broadcasting service in portable terminals.

In current portable terminals, it takes at least 1.5 seconds to receive and display the contents broadcast on a selected DMB channel after the channel is selected. Therefore, in conventional portable terminals, during the time that it takes to receive and display contents broadcast on a certain channel, a pre-stored still or moving image is displayed. However, because the still or moving image that is displayed has no relation to the broadcast contents of the channel that the user wants to view, the user is not afforded information on the contents of the channel selected or switched to for viewing.

ESG and EPG data for displaying data of broadcast contents and data of each server channel is used to display data of broadcast contents for each channel, in order to display only the titles or durations of the broadcast contents of each channel in text format when the channel selection menu is displayed. In displaying the channel selection menu, the method of displaying data of contents through text has the drawback of a user being unable to know the type of contents or their characteristics without reading the text in detail. Also, when the user attempts to switch channels while viewing the contents of a certain channel, the user is unable to know what kinds of contents are broadcast on the switched channel until the contents of the switched channel are received.

### SUMMARY OF THE INVENTION

An object of the present invention is to solve at least the above problems and/or disadvantages and to provide at least the advantages below. Accordingly, an object of the present invention is to provide an apparatus and method for offering digital multimedia broadcasting service in a portable terminal.

Another object of the present invention is to provide a method and apparatus for using ESG or EPG in a portable terminal to display the characteristics of contents broadcast on each channel.

Another object of the present invention is to provide a method and apparatus for displaying contents broadcast on each channel through a still or moving image in a portable terminal.

According to a first aspect of the present invention, there is provided a method of providing DMB (Digital Multimedia Broadcasting) in a portable terminal, including analyzing received ESG (Electronic Service Guide) data or EPG (Electronic Program Guide) data and checking characteristics of broadcast contents of respective channels, when a DMB view request event occurs; mapping contents of the respective channels with pre-stored images having the same characteristics as the checked characteristics; displaying a list of the respective channels, and receiving a selection of a certain channel from a user; and displaying an image mapped with contents of the certain channel until the contents of the certain channel are received.

According to a second aspect of the present invention, there is provided an apparatus for providing DMB in a portable terminal, including a storage for storing at least one image having a predetermined characteristic; an RF (radio frequency) module for receiving contents broadcast on a certain channel selected by a user; a controller for analyzing ESG data or EPG data and checking characteristics of contents broadcast on respective channels, and outputting an image having the same characteristics as contents of the certain channel until the contents of the certain channel are received; and a display for displaying an image outputted by the controller.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a portable terminal according to the present invention;

FIG. 2 is a flowchart of a process for displaying content data broadcast on each channel in a portable terminal according to the present invention;

FIGS. 3A and 3B are diagrams showing screen layouts displaying content data broadcast on each channel in a portable terminal according to the present invention; and

FIG. 4 is a diagram showing screen layouts displaying broadcast content data when channels are changed in a portable terminal according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

Below, an apparatus and method for using ESG or EPG data in a portable terminal to display images showing characteristics of the broadcast contents of each channel will be described. Here, the ESG data includes the titles of the broadcast contents, the type of contents, the start, end, and duration times, content format (data on the type of service), etc., and the EPG data includes simplified service channel data and program data for each service channel.

In the below description, a portable terminal denotes all types of terminals that are capable of receiving digital multimedia broadcasts, and an image includes both still and moving images.

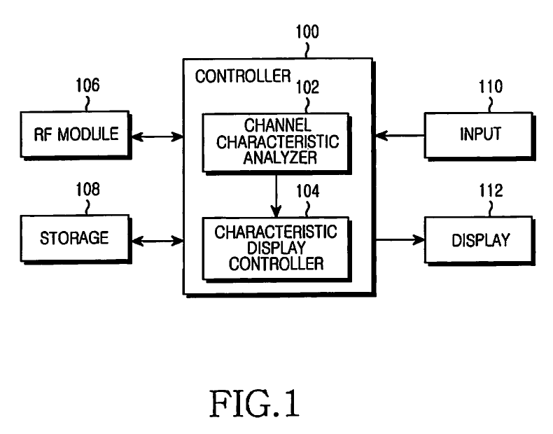

Referring to FIG. 1, the portable terminal is configured to include a controller 100, a channel characteristic analyzer 102, a characteristic display controller 104, a radio frequency (RF) module 106, a storage 108, an input 110, and a display 112.

The controller 100 performs the overall controlling of the portable terminal—for example, the processing and controlling of data communication. That is, when a digital multimedia broadcast request event occurs, controller 100 uses ESG and EPG data received through RF module 106 from a broadcast server to display a list providing channel contents information on display 110, and processes and controls functions for receiving and playing back the broadcast contents of a channel selected by a user. Because controller 100 in the present invention particularly includes channel characteristic analyzer 102 and characteristic display controller 104, controller 100 controls and processes functions for displaying the content characteristics of each broadcast channel as an image displayed on display 110.

Channel characteristic analyzer 102 analyzes the ESG and EPG data provided by RF module 106 and checks the characteristics of the contents broadcast in each channel. Here, the content characteristics reflect the type of contents or titles of contents, and contents titles, type, or even technical terms may be checked from the content characteristics. Then, channel characteristic analyzer 102 reads images having the same content characteristics as characteristics of verified contents of images pre-stored in storage 108, and maps the contents into the images, after which the mapped results are provided to characteristic display controller 104. For example, when channel characteristic analyzer 102 determines from the analyzed results of the ESG and EPG data that ‘baseball’ is content characteristic A, then images defined as ‘baseball’ from images pre-stored in storage 108 may be matched with content characteristic A.

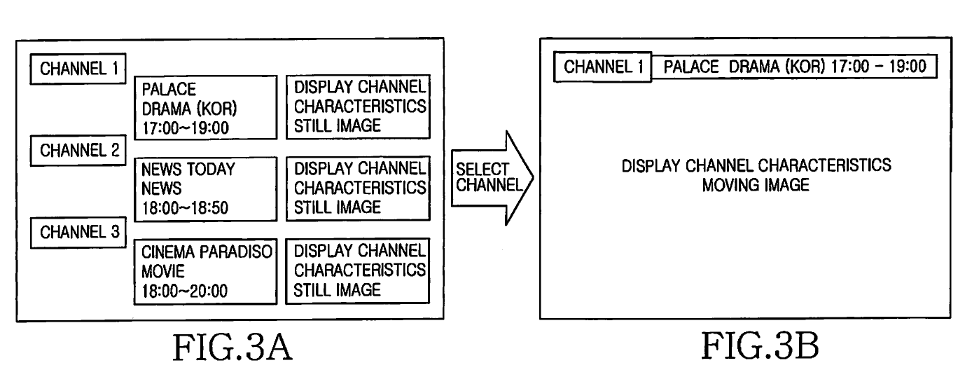

Characteristic display controller 104 receives the contents and images mapped by channel characteristic analyzer 102, and displays text representing the data of contents broadcast on each of the channels while simultaneously controlling and processing a function for displaying the image mapped with the contents broadcast on each of the channels on display 112 (as shown in FIG. 3A), when a user request event for displaying a list of channels of the DMB service occurs. Also, when a user selects a certain channel or attempts to switch from one channel to another channel, characteristic display controller 104 controls and processes a function for displaying text data on the relevant contents and an image mapped with the relevant contents on display 112 (as shown in FIG. 3B), before the certain channel is obtained and the contents are received. Here, when one still image and one moving image are mapped with the contents, the still image may be displayed when displaying the channel list, and the moving image may be displayed when selecting or switching the channel.

RF module 106 performs the function of receiving a DMB signal according to the controlling of controller 100. In other words, RF module 106 receives ESG and EPG data and provides the same to controller 100, and receives contents broadcast in a certain channel to provide to controller 100 when reception of that broadcast channel is requested by controller 100.

Storage 108 stores programs for controlling and processing the overall operation of the portable terminal and various reference data, and stores still images and moving images having predetermined characteristics, according to the present invention. For example, storage 108 may store a moving picture defined with characteristics for ‘Baseball’, a still image defined with characteristics for ‘Drama’, a still image defined with characteristics for ‘News’, and a moving image defined with characteristics for ‘Movies’. Here, the still images and moving images stored in storage 108 may be received through a network from a broadcast providing server, and storage 108 may be connected to a computer so that a user may alter the images.

Input 110 includes a plurality of number and other character keys as well as function keys, and provides signals for functions corresponding to keys that are selected by a user to controller 100. In the present invention, input 110 especially receives a user-inputted selection of one channel from a list of broadcast channels, and provides that selection to controller 100.

Display 112 displays data on the state of the portable terminal during its operation, as well as numbers, letters, and images. Display 112 according to the present invention especially displays images of broadcast contents played back by controller 100, and displays images mapped with corresponding contents according to the controlling of characteristic display controller 104 of controller 100.

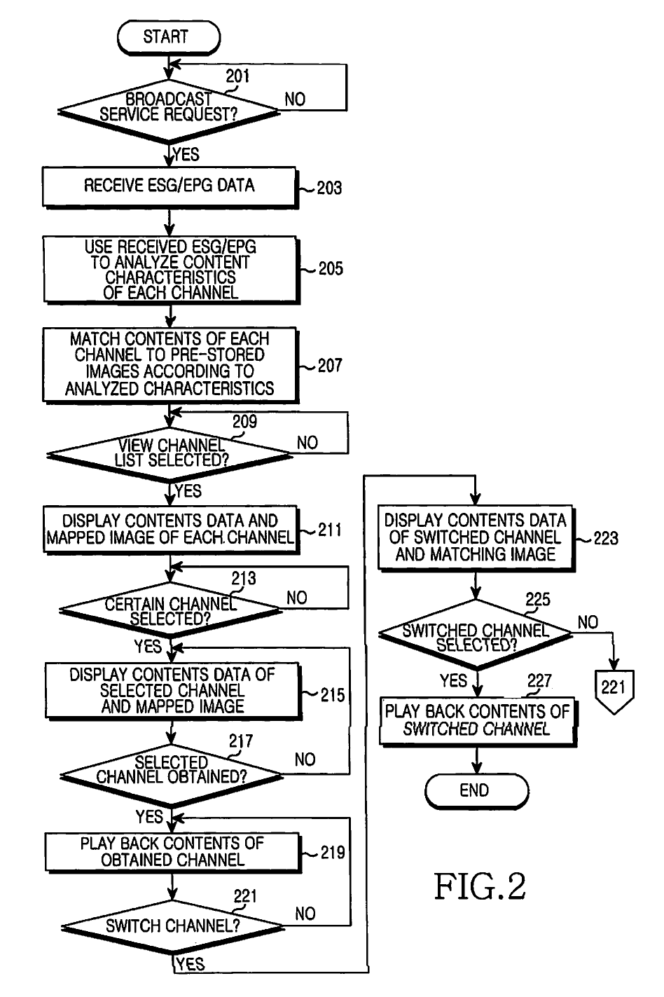

Referring to FIG. 2, first in step 201, the terminal detects whether there is an event requesting DMB service through the manipulating of the keys by a user. When an event requesting DMB service occurs, the terminal performs step 203 in which it receives ESG and EPG data (that includes data on the contents that are broadcast in the respective channels) from the broadcast data providing server.

Then, the terminal performs step 205 in which the received ESG and EPG data is analyzed to check the characteristics of the broadcast contents of each channel, after which images from those stored in storage 108 (that have the same characteristics as the checked characteristics of the broadcast contents) are checked and mapped with the broadcast contents. Here, the characteristics of the contents denote the type or title of contents, so that the titles, types, or even formats of the contents included in the ESG and EPG can be used and checked.

Next, in step 209, the terminal detects if a menu for viewing a list of channels for displaying data on contents broadcast by each channel has been selected through a key manipulation by the user. If the viewing of the channel list has been selected, the terminal performs step 211 in which it analyzes the ESG and EPG data, and displays text data of the contents broadcast in each channel and images that are mapped with the contents. For example, as shown in FIG. 3A, the type of contents, the starting time, and the ending time may be displayed for each program, ‘Palace’, ‘News Today’, and ‘Cinema Paradiso’ broadcast respectively on Channels 1, 2, and 3; and images showing the respective characteristics of ‘Palace’, ‘News Today’, and ‘Cinema Paradiso’ may also be displayed.

Next, in step 213, the terminal detects whether contents of a certain channel from the displayed channel list have been selected. If the contents of the channel have been selected, the terminal performs step 215 in which it attempts to receive the contents broadcast on the selected channel, and displays text data of the contents and an image mapped with the contents (as shown in FIG. 3B). Then, the terminal detects if the channel has been obtained, and the contents are received in step 217. If the channel has not been obtained and the contents are not received, the terminal returns to step 215 in order to display text data of the contents and an image mapped with the contents. That is, the terminal displays text data of the contents and an image mapped with the contents up to the point when the contents are received, so that a user is informed of contents broadcast on a particular channel prior to receiving the broadcast. On the other hand, if the channel is secured and the contents are received, the terminal performs step 219 in which the contents received from the channel are played back.

Next, the terminal detects in step 221 if a channel-switching event by means of a user's key manipulation occurs. If a channel-switching event has not occurred, the terminal continues to play back the contents being received in step 219.

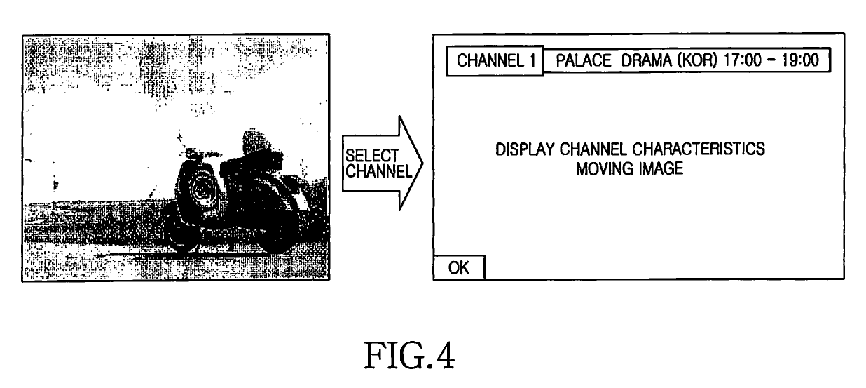

If a channel-switching event occurs, the terminal performs step 223 in which it attempts to receive the contents broadcast in the new channel switched to by the user, checks the contents broadcast in the switched channel through the ESG and EPG data, and displays text data on the checked contents and an image mapped with the contents. For example, as shown in FIG. 4, during the playback of contents of a particular channel, when a channel switching event by a user to Channel 1 occurs, text showing the content title ‘Palace’, content type ‘Drama’, and content broadcast time ‘17:00-19:00’ may be displayed, and a still or moving picture designated for ‘Drama’ or ‘Palace’ may be displayed.

Then, the terminal performs step 225 in which it detects whether the switched channel has been selected by the user in order to view the switched channel. If the switched channel has been selected, the terminal performs step 227 in which it receives and plays back the contents broadcast in the switched channel, and then ends the process. Here, when there is a request to change the channel, the terminal attempts to receive the contents broadcast in the channel to be switched to, displays text and an image representing the content data, and selects the switched channel and plays back its contents, such that the time it takes to switch channels is imperceptible to the user.

Conversely, when the channel for switching is not selected, the terminal returns to step 221 and performs the subsequent steps again.

In the above-described portable terminal according to the present invention, ESG and EPG data is used to determine the characteristics of contents broadcast in each DMB channel; and still or moving images having the same characteristics as the respective contents are mapped, and the mapped still or moving images are displayed until the contents broadcast by a selected channel are received. Thus, the delay for playing back contents (caused by the time that it takes to obtain a selected or switched channel) can be rendered imperceptible to a user, and the user is given an advance preview of what the contents of a selected or switched channel are.

While the invention has been shown and described with reference to certain preferred embodiments thereof, it will be understood by those skilled in the art that various changes in form and details may be made therein without departing from the spirit and scope of the invention as further defined by the appended claims.

What is claimed is:

1. A method of providing DMB (Digital Multimedia Broadcasting) in a portable terminal, comprising the steps of:
analyzing one of received ESG (Electronic Service Guide) data or EPG (Electronic Program Guide) data and checking characteristics of broadcast contents of respective channels, when a DMB view request event occurs;
mapping contents of the respective channels with pre-stored images having the same characteristics as the checked characteristics;
displaying a list of the respective channels, and receiving a selection of a certain channel from a user; and
displaying an image mapped with contents of the certain channel until the contents of the certain channel are received.

2. The method of claim 1, further comprising playing back the received contents when the contents of the certain channel are received.

3. The method of claim 1, wherein the displayed list of the respective channels comprises data on broadcast contents according to each channel and images mapped with the respective contents.

4. The method of claim 1, wherein images mapped with the respective contents include at least one of a still image and a moving image.

5. The method of claim 1, further comprising:
displaying an image mapped with contents of another channel until the contents of the other channel are received, when a channel switching event for switching from the selected channel to the other channel occurs; and
playing back the received contents when the contents of the switched channel are received.

6. An apparatus for providing DMB in a portable terminal, comprising:
a storage for storing at least one image having a predetermined characteristic;
an RF (radio frequency) module for receiving contents broadcast on a certain channel selected by a user;
a controller for analyzing one of ESG data and EPG data and checking characteristics of contents broadcast on respective channels, and outputting an image having the same characteristics as contents of the certain channel until the contents of the certain channel are received; and
a display for displaying an image outputted by the controller.

7. The apparatus of claim 6, wherein the controller plays back the contents of the certain channel when the contents of the certain channel are received.

8. The apparatus of claim 6, wherein the controller comprises:
a characteristic analyzer for analyzing one of the ESG data or the EPG data to check characteristics of broadcast contents according to the respective channels, and mapping contents of the respective channels with the checked characteristics and images having the same characteristics; and
a characteristic display controller for outputting the image mapped with the contents of the certain channel from after the selection of the certain channel until the contents of the certain channel are received.

9. The apparatus of claim 6, wherein the controller outputs data on contents broadcast on each channel and images mapped with respective contents of the broadcast channels to the display, when a DMB channel list display event occurs.

10. The apparatus of claim 6, wherein the image having the predetermined characteristic comprises at least one of a still image and a moving image.

11. An apparatus for providing DMB (Digital Multimedia Broadcasting) in a portable terminal, comprising:
means for analyzing one of received ESG (Electronic Service Guide) data or EPG (Electronic Program Guide) data and checking characteristics of broadcast contents of respective channels;
means for mapping contents of the respective channels with pre-stored images having the same characteristics as the checked characteristics;
means for displaying a list of the respective channels; and
means for displaying an image mapped with contents of a selected channel.

12. The apparatus of claim 11, wherein the displayed list of the respective channels comprises data on broadcast contents according to each channel and images mapped with the respective contents.
